(19) United States
(12) Patent Application Publication
(10) Pub. No.: US 2026/0039925 A1
(43) Pub. Date: Feb. 5, 2026

(54) METHOD AND APPARATUS FOR MULTIPLE DIGITAL WATERMARKING

(71) Applicant: MARKANY INC., Seoul (KR)

(72) Inventor: Tai Yoon LEE, Seoul (KR)

(73) Assignee: MARKANY INC., Seoul (KR)

(21) Appl. No.: 19/278,643

(22) Filed: Jul. 23, 2025

(30) Foreign Application Priority Data
Jul. 31, 2024 (KR) 10-2024-0101984

(51) Int. Cl. H04N 21/8358

(52) U.S. Cl. CPC H04N 21/8358

(57) ABSTRACT

The present invention relates to a method and apparatus for hiding information in digital media using watermark embedding, and more particularly, to a method and apparatus for embedding a watermark that is robust against redundant insertion. According to one embodiment of the present invention, a watermark embedding method for digital media comprises: receiving first digital media into which a first watermark has been embedded; generating a second watermark; embedding the second watermark into the first digital media to generate second digital media; and outputting the second digital media. The resulting second digital media may be characterized in that the first watermark and the second watermark are each individually detectable.

### CROSS REFERENCE TO RELATED APPLICATION

This application claims priority from Republic of Korea Patent Application No. 10-2024-0101984, filed on Jul. 31, 2024, which is hereby incorporated by reference in its entirety.

### FIELD OF INVENTION

The present invention relates to a method and apparatus for embedding a watermark to hide information within digital media. More specifically, the present invention relates to a method and apparatus for embedding watermarks that are robust against multiple insertions.

### BACKGROUND

Recently, nearly every aspect of daily life and services—including office work, payment services, certificate issuance, banking, e-commerce, and the creation and provision of cultural media—has become reliant on online and computerized environments. In such online and computerized environments, digital media is used for generating, displaying, storing, editing, and transmitting information. As used herein, digital media refers to various forms of digital information including images, text, and multimedia; for example, digital documents, pictures, audio, video, and three-dimensional data.

However, due to the inherent characteristics of digital information, digital media can be easily replicated or transmitted without any loss of information, making it highly vulnerable to unauthorized disclosure, i.e., “leakage”. Therefore, to maintain a secure digital media environment, protection measures (i.e., security systems) are essential to guard digital media against illicit actions. For instance, digital media can be safeguarded through encryption and decryption systems, watermarking or fingerprinting systems, or screen capture prevention systems.

Digital watermarking is one such approach. Many commonly used digital watermarking techniques involve embedding predetermined auxiliary information in a digital media by applying a machine-readable manipulation at specified temporal or spatial locations. The embedded auxiliary information can subsequently be detected by devices or software configured to detect such manipulations, through analysis of the watermarked digital media.

The auxiliary information may indicate digital media ownership or restrict copying or displaying. Such auxiliary information can be made virtually imperceptible to human observers through imperceptible but machine-readable manipulations.

Recently, forensic watermarking methods, which embed traceability information using digital watermarking into distributed videos, have gained usage. This approach involves embedding information regarding the recipient of the digital media, which can aid in identifying individuals who have used digital media through unauthorized means or have participated in the illegal leakage of digital media.

Notably, such leakage may occur not only at the final consumption stage but also during the production, processing, and/or distribution stages of digital media. Anyone involved in handling digital media prior to its distribution may be presumed to have the opportunity to participate in the leakage of such digital media content. To preempt such incidents via digital watermarking, forensic watermarking must be performed for each organization and/or person handling the digital media. This requires embedding watermarks two or more times on the same digital media.

### SUMMARY

Conventionally, when multiple watermarks are embedded in the same digital media, mutual interference between the watermarks is known to degrade the detection efficiency of each individual watermark. Therefore, it has been necessary to avoid multiple watermark embeddings or, if unavoidable, to minimize the number of embeddings such that detection reliability is not compromised.

To address the aforementioned technical challenge, one embodiment of the present invention provides a method for embedding a watermark into digital media, the method comprising: receiving a first digital media into which a first watermark has already been embedded; generating a second watermark; embedding the second watermark into the first digital media to produce a second digital media; and outputting the second digital media. The second digital media enables independent detection of both the first watermark and the second watermark.

The second watermark may be embedded such that it is orthogonal to the first watermark. In certain embodiments, the second watermark is embedded to be orthogonal to the first watermark in the frequency domain.

The step of generating the second watermark may include: extracting the first watermark from the first digital media; determining a first carrier frequency of the first watermark; selecting a second carrier frequency orthogonal to the first carrier frequency; and generating the second watermark based on the second carrier frequency.

The first and second carrier frequencies may be determined by different coefficient values of a discrete cosine transform.

The second watermark may be embedded with a different granularity than the first watermark. This difference in granularity may include having a multiple of two in at least one direction, either horizontally or vertically.

The step of generating the second watermark may further include: extracting the first watermark from the first digital media; extracting first watermark information from the first watermark; generating second watermark information based on the first watermark information; and generating the second watermark based on the second watermark information.

In one embodiment, the step of generating the second watermark information includes extracting at least one number from the first watermark information, performing an operation based on the extracted number to produce a result, and generating the second watermark information based on that result.

The step of embedding the second watermark may be combined and performed as part of the encoding process of the second digital media.

The second watermark may include, as information to be embedded, one or more of: the time of receipt of the first digital media, the date of receipt, device identification information, and user identification information of the device used for input.

Upon outputting the second digital media, the second watermark may include, as embedded information, one or more of: the time and date of output, device identification information, and user identification information of the output device.

Both the first and second watermarks may include information relating to the number of times watermarks have been embedded. The information regarding the number of embeddings included in the second watermark indicates a higher number than that included in the first watermark.

The step of generating the second watermark may include: extracting the first watermark from the first digital media; extracting information regarding watermark embedding count from the first watermark; incrementing the embedding count by at least one; and generating the second watermark to include the updated embedding count information.

To solve the aforementioned technical problem, another embodiment provides an apparatus for embedding a watermark into digital media, comprising: an input module for receiving a first digital media with a first watermark embedded; a watermark generation module for generating a second watermark; a watermark embedding module for embedding the second watermark into the first digital media to produce a second digital media; and an output module for outputting the second digital media. The second digital media is characterized in that both the first and second watermarks can be independently detected.

The second watermark may be embedded such that it is orthogonal to the first watermark, or with a different granularity.

The watermark generation module may be configured to extract a first watermark from the first digital media, extract first watermark information, generate second watermark information based on the first watermark information, and generate the second watermark based on the second watermark information.

The watermark embedding module may comprise an encoder for encoding the second digital media.

Both the first and second watermarks may include information relating to the number of times watermarks have been embedded, and the second watermark may include a larger value relating to the number of embeddings than the first watermark.

According to the present invention, watermarks that can be robustly and independently detected, even in the case of redundant embedding, are provided. This enables repeated watermark embedding at each step in the handling of digital media at risk of leakage, without affecting watermark detection reliability.

### BRIEF DESCRIPTION OF THE DRAWINGS

FIG. 1 is a conceptual diagram illustrating a digital media processing procedure to which the present invention can be applied.

FIG. 2 is a flowchart illustrating a method for embedding a watermark into digital media according to one embodiment of the present invention.

FIG. 3 is a conceptual diagram illustrating orthogonality in the frequency domain according to an embodiment of the present invention.

FIG. 4 is a flowchart illustrating a method for generating and embedding a second watermark according to one embodiment of the present invention.

FIG. 5 is a conceptual diagram illustrating non-interference according to the difference in granularity in one embodiment of the present invention.

FIG. 6 is a flowchart illustrating a method for generating and embedding a second watermark with reference to a first watermark according to one embodiment of the present invention.

FIG. 7 is an exemplary diagram illustrating a reference based on operations between a first watermark and a second watermark according to one embodiment of the present invention.

FIG. 8 is an exemplary diagram illustrating a reference based on incrementing the watermark count between a first watermark and a second watermark according to one embodiment of the present invention.

FIG. 9 is a conceptual diagram of a digital watermark embedding apparatus according to one embodiment of the present invention.

### DESCRIPTION OF EXEMPLARY EMBODIMENTS

The present invention is subject to various modifications and encompasses multiple embodiments. Specific embodiments are illustrated in the drawings and described in detail below. However, these are not intended to limit the invention to particular forms, and it will be understood that all modifications, equivalents, and substitutions falling within the spirit and scope of the present invention are intended to be covered.

The terms “first,” “second,” and the like may be used to describe multiple elements, but such elements should not be limited by these terms. The terminology is used solely for distinguishing one element from another. For example, within the scope of the present invention, a first element may be referred to as a second element and, likewise, a second element may be referred to as a first element without departing from the inventive concept. The term “and/or” is inclusive, meaning any combination or any of the listed items, unless clearly indicated otherwise.

When the present application enumerates items, those statements are intended to facilitate comprehension of the invention and illustrative manners of implementation, and are not intended to limit the scope of the embodiments of the present invention.

As used herein, the phrase “A or B” may mean “only A,” “only B,” or “both A and B.” In other words, “A or B” as used in this specification may be interpreted as “A and/or B.” For example, “A, B, or C” may mean “only A,” “only B,” “only C,” or “any combination of A, B, and C.”

When a slash (/) or a comma appears in this specification, it may mean “and/or.” For example, “A/B” may mean “A and/or B,” and accordingly may represent “only A,” “only B,” or “both A and B.” Similarly, “A, B, C” may mean “A, B, or C.”

The phrase “at least one of A and B” may mean “only A,” “only B,” or “both A and B.” Likewise, the expressions “at least one of A or B” and “at least one of A and/or B” may be interpreted in the same way as “at least one of A and B.”

Additionally, the phrase “at least one of A, B, and C” means “only A,” “only B,” “only C,” or “any combination of A, B, and C.” Similarly, the phrases “at least one of A, B, or C” and “at least one of A, B, and/or C” should be understood to have the same meaning as “at least one of A, B, and C.”

When a component is described as being “connected” or “coupled” to another component, it should be understood that the connection or coupling may be direct or via one or more intervening elements. Conversely, when a component is referred to as “directly connected” or “directly coupled,” it should be understood that there are no intervening elements between them.

The terminology used herein is for the purpose of describing particular embodiments only and is not intended to be limiting of the invention. As used herein, the singular forms are intended to include the plural forms as well, unless the context clearly indicates otherwise. Terms such as “include” or “have” or their variants specify the presence of stated features, steps, operations, components, or combinations thereof, but do not preclude the presence or addition of one or more other features, steps, operations, components, or combinations thereof.

Unless otherwise defined, all technical and scientific terms used herein have the same meaning as commonly understood by one of ordinary skill in the art to which this invention pertains. Terms that are defined in commonly used dictionaries should be interpreted as having a meaning that is consistent with their use in the context of the relevant technical field and are not to be interpreted in an idealized or overly formal sense unless expressly so defined herein.

The embodiments of the present invention may be described or illustrated in the form of functional blocks that perform one or more functions. These blocks may be implemented as one or more devices, units, modules, or components. The blocks may be implemented in hardware by means of one or more logic gates, integrated circuits, processors, controllers, memory, electronic components, or any information processing hardware. Conversely, the blocks may be implemented in software by application software, an operating system, firmware, or any information processing software. A functional block may be divided into multiple blocks performing the same function or, conversely, multiple blocks may be integrated into a single block performing the functions of those blocks. Blocks may also be physically separated or merged based on any desirable criteria. Furthermore, blocks may operate in a distributed environment where physical locations are not specified, such as over a communication network, the Internet, cloud services, or the like. All such implementations are within the technical scope of this invention and may be adopted by those skilled in the art to realize the invention.

Hereinafter, preferred embodiments of the present invention will be described in detail with reference to the accompanying drawings. To facilitate overall understanding, like reference numerals are used for the same or similar elements throughout the drawings, and redundant descriptions are omitted. Multiple embodiments are not mutually exclusive and, in some instances, may be combined with one or more other embodiments to create new embodiments.

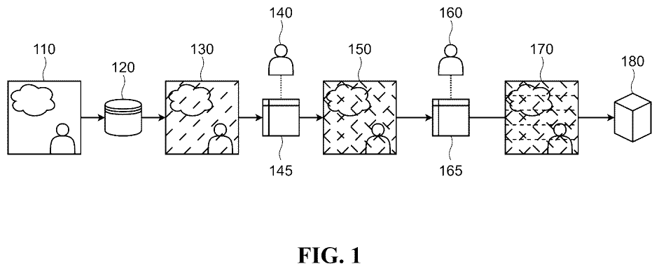

FIG. 1 is a conceptual diagram illustrating a process for handling digital media to which the present invention can be applied. As described above, the illegal leakage of digital media may occur not only at the final consumption stage, but also during the production, editing, and/or distribution stages of digital media. FIG. 1 shows a conceptual diagram illustrating such cases.

In the present invention, digital media 110 is subject to processing and watermark embedding. According to a preferred embodiment, the digital media 110 may be a two-dimensional image, and, for clarity and convenience, this disclosure will use a two-dimensional image as a representative example. However, those skilled in the art will appreciate that the invention is equally applicable to other types of digital media such as video (implemented as a combination of still images), audio, three-dimensional images, holograms, and any digital signal-based media. All such modified implementations are considered to be within the scope of this disclosure.

The original digital media 110 may be processed for editing, modification, and/or distribution by various persons, organizations, institutions, and/or devices. For such processing, the digital media 110 may be provided to storage device 120. Subsequently, the first watermarked digital media 130 may be transferred from storage device 120 to first device 145 in order to be processed by first operator 140. During this step, the digital media 110 may be altered into the form of first watermarked digital media 130 through the insertion of a first watermark. The first watermark embedded in the first watermarked digital media may include at least one piece of information identifying first operator 140 and/or first device 145. If the first watermarked digital media 130 is leaked, the source of the leak can be identified as being associated with the first operator 140 and/or first device 145 by detecting the first watermark, enabling subsequent disciplinary action. As a result, the risk of unauthorized leakage can be deterred.

The present invention addresses the issue of redundant watermark embedding in digital media. After processing by the first operator 140, the digital media may subsequently be transferred from first device 145 to second device 165 for handling by second operator 160. At this stage, the first watermarked digital media 130 may be further embedded with a second watermark, thereby being converted into second watermarked digital media 150. The second watermark embedded in the second watermarked digital media may include at least one piece of information identifying second operator 160 and/or second device 165. Moreover, the second watermark may be inserted in a manner that does not interfere with detection of the first watermark. In other words, in the second watermarked digital media, the first and second watermarks may each exist in a state where they are individually detectable. If the second watermarked digital media 150 is leaked, identification of the second watermark allows the source of the leak to be traced to second operator 160 and/or second device 165, while also confirming that the digital media was passed through first operator 140 and/or first device 145. This enhances the ability to trace the history of a leak, thereby further strengthening the efficacy of disciplinary actions and leakage prevention.

Furthermore, second operator 160 may wish to provide the second watermarked digital media 150 to an external recipient 180, such as another organization. In this case, a third watermark may be additionally embedded in the second watermarked digital media 150, converting it into third watermarked digital media 170. The third watermark embedded in the third watermarked digital media may include at least one piece of information for identifying external recipient 180. At the same time, the third watermark may be embedded using a method that does not impede detection of the first and second watermarks. That is, in the third watermarked digital media, the first, second, and third watermarks may each exist in individually detectable states. Should the third watermarked digital media 170 be leaked, it is possible—by identifying the third watermark—to achieve the aforementioned benefits of robust disciplinary control and enhanced leakage prevention.

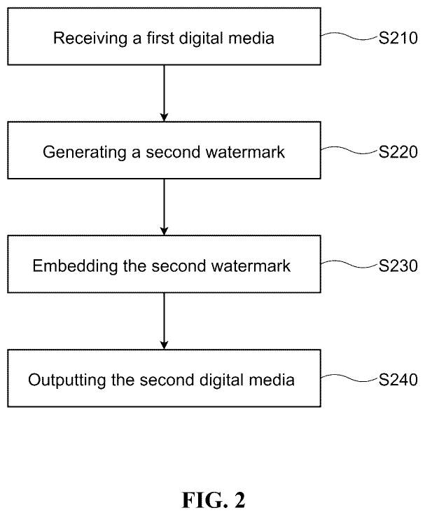

FIG. 2 is a flowchart illustrating a method for embedding a watermark into digital media according to an embodiment of the present invention. The watermark embedding method for digital media may include: a step of receiving a first digital media (step S210); a step of generating a second watermark (step S220); a step of embedding the second watermark into the digital media to generate a second digital media (step S230); and a step of outputting the second digital media (step S240).

In step S210, receiving the first digital media may involve receiving digital media over a digital communication network, reading digital media stored in fixed or removable digital storage media, or acquiring digital media generated in real time from input devices such as a camera or audio recorder. It is obvious that a variety of other methods for inputting digital media data may be implemented and are within the scope of the invention.

According to a preferred embodiment, the first digital media received in step S210 may already have at least one pre-existing watermark embedded therein, such as a first watermark. Since the present invention concerns redundant watermark embedding, the watermark inserted according to the invention will generally be referred to as the second watermark herein.

In step S220 where the second watermark is generated and step S230 where the second watermark is embedded in the digital media to create a second digital media, the second digital media may be created such that the first watermark and the second watermark can each be detected individually. This is consistent with the applicable scenarios of the invention as previously described with reference to FIG. 1. The following describes certain, non-limiting implementation methods for achieving such individual detectability.

According to one embodiment, the second watermark may be embedded in a non-interfering manner with regard to the first watermark. Here, “non-interfering” means that, depending on the digital watermarking method applied, the second watermark is embedded in a manner and/or at a level that does not prevent normal detection of the first watermark within an allowed margin of error. It does not necessarily require complete elimination or removal of all informational or signal interference between the two watermarks.

According to an embodiment of the invention, to achieve such non-interfering embedding, the second watermark may be embedded in a form that is orthogonal to the first watermark. As generally understood in the art, the term “orthogonal” may mean that the inner product of two signals is zero (0); in this invention, however, the term may be defined to include cases where the inner product falls within an allowable margin of error, such that the first and second watermarks are effectively “non-interfering”.

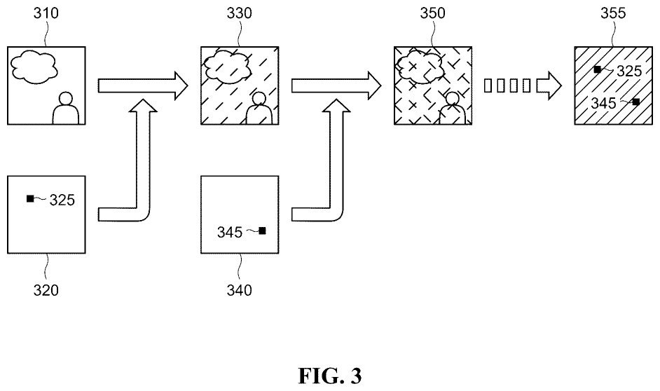

More specifically, the second watermark may be embedded such that it is orthogonal to the first watermark in the frequency domain. FIG. 3 is a conceptual diagram related to the principle of orthogonality in the frequency domain according to one embodiment of the invention. Suppose a first watermark 320 is embedded in the original digital media 310. The first watermark 320 may comprise frequency-domain information, such as transform coefficients, and may be embedded by adding a first signal 325 having a first frequency to the given digital media. The resulting watermarked digital media 330 may then be further embedded with a second watermark 340. The second watermark 340 also contains frequency-domain information and may be embedded by adding a second signal 345 with a second frequency to the digital media. Second watermarked digital media is produced 350 consequently. By extracting the frequency-domain information from the resulting second watermarked digital media 355, both the first signal 325 and the second signal 345 that were embedded can be extracted without mutual interference.

According to the above principle, the present invention enables redundant watermarks to be embedded so as to be individually detectable without mutual interference, even in the case of multiple embedded watermarks.

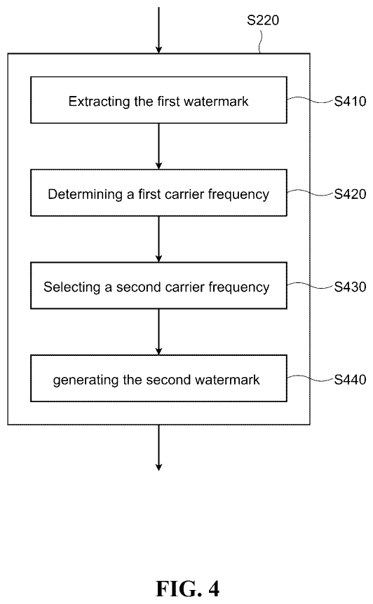

FIG. 4 is a flowchart illustrating a method for generating and embedding a second watermark according to an embodiment of the present invention. Referring to FIG. 4, the step S220 of generating the second watermark shown in FIG. 2 may include: extracting the first watermark from the digital media (step S410), determining a first carrier frequency of the first watermark (step S420), selecting a second carrier frequency that is orthogonal to the first carrier frequency (step S430), and generating the second watermark based on the second carrier frequency (step S440).

In this embodiment of the invention as shown in the flowchart of FIG. 4, the first watermark and/or the second watermark may be digital watermarks embedded in the frequency domain. Specifically, the first and/or second watermarks may be generated and embedded using a digital watermarking technique in which watermark information is inserted by either augmenting or attenuating at least one spatial frequency signal within the original digital media. In one embodiment, the first and/or second watermark may be generated and/or embedded by adding or subtracting at least one coefficient value of a discrete cosine transform. It will be readily understood by those skilled in the art that each coefficient corresponds to an individual orthogonal frequency useful for reconstructing a specific digital signal. Thus, the first watermark may be embedded by manipulating a certain coefficient value (by addition or subtraction) as the watermark, and this value may be considered to represent the carrier frequency of the first watermark.

Accordingly, if the step of extracting the first watermark (step S410) results in obtaining the first watermark including frequency-domain information, it is then possible to determine (step S420) the carrier frequency used to embed the first watermark. Next, based on the first carrier frequency, a second carrier frequency orthogonal to the first one may be selected (step S430). Since the selected second carrier frequency is orthogonal to the first carrier frequency, information modulated onto the second carrier frequency will not be expected to interfere with the information on the first carrier frequency. Accordingly, by generating (step S440) the second watermark in the region of the second carrier frequency, a second watermark may be created which can be individually detected apart from the first watermark.

According to one embodiment of the present invention, to achieve non-interfering embedding, the second watermark may be embedded with a difference in granularity compared to the first watermark. In a preferred embodiment, this granularity difference may be a multiple of two in at least one direction (horizontal or vertical). Said multiple of two includes powers of two, including, for example, cases where the granularity is four times or half that of the other watermark.

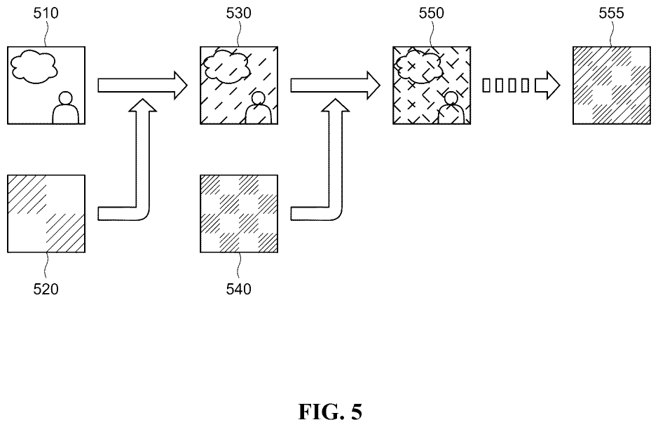

FIG. 5 is a conceptual diagram illustrating non-interference based on differences in granularity, according to one embodiment of the present invention. Suppose a first watermark 520 is embedded in the original digital media 510. For example, if the digital media is a digital image, the first watermark 520 may be embedded by modifying information of each region after dividing the image into a grid of 2 columns by 2 rows. In this case, the granularity of the first watermark 520 can be understood as half the width and height of the digital image. The first watermark can be embedded, for instance, using a pattern overlay-based watermarking technique such as the one disclosed by the same applicant in Korean Patent No. 2384008, resulting in first watermarked digital media 530. Korean Patent No. 2384008 is hereby incorporated by reference in its entirety.

Subsequently, a second watermark 540 may be embedded in the first watermarked digital media 530. For example, the second watermark 540 may be embedded by modifying the information in each region after dividing the image into a 4-by-4 grid. In this scenario, the granularity of the second watermark 540 can be considered as a quarter of the digital image's dimensions. The second watermark 540 is embedded using the same or a similar method as above, leading to the generation of second watermarked digital media 550. When watermarks are extracted from the second watermarked digital media via units determined by modulation 555, the different granularities at which the first watermark 520 and second watermark 540 were embedded ensure that the two can be independently extracted without mutual interference. Thus, according to this principle, the invention enables embedding of redundant, non-interfering watermarks so that each can be individually detected.

In one embodiment of the present invention, the step of generating the second watermark (step S220) may be configured to insert a predetermined set of information as the second watermark.

The set of information may include content-related information such as the title, length, type, language, subtitles, copyright holder, distributor, supply channel, or viewing age limits of the digital media. Alternatively, the set of information may include security information, such as copy permission, copy protection, or traceability information. More specifically, the traceability information may serve to control devices that receive or display the digital media, such as metadata for value-added services or terminal control commands that devices recognize as signals.

This set of information may be traceability information to distinguish and uniquely identify one distributed copy of the digital media from another. Such traceability information may include device-specific identification, such as the type of device hardware, device hardware identifier (e.g., device UUID), device software identifier, device software version, or any information necessary to identify the device.

The traceability information may further include information related to the means of distribution. The distribution method may use any conventional wired or wireless digital communication network, hardwired cabling, or physical recording media including hard disks, optical media, or flash memory. Therefore, the traceability information, if the distribution is over a communication network, may include the device's network address, network interface identifier, or network routing information; if through wired cabling, it may include identification of the wiring route; and if by physical recording media, it may include a unique identifier for the media.

The traceability information may also include identifiers related to users of the device, such as user ID (e.g., service ID), personal identifiers (e.g., name, authentication details), organizational information (e.g., name of affiliated organization and/or department), or any information necessary to identify the user.

In an embodiment of the invention, the traceability information may, in the receiving step (step S210) of the first digital media as illustrated in FIG. 2, include at least one of: the time of receipt, date of receipt, identification of the receiving device, or identification of the user of the receiving device.

In another embodiment, in the outputting step (step S240) of the second digital media as illustrated in FIG. 2, the traceability information may include at least one of: time and date of output, identification of the output device, and identification of the user of the output device.

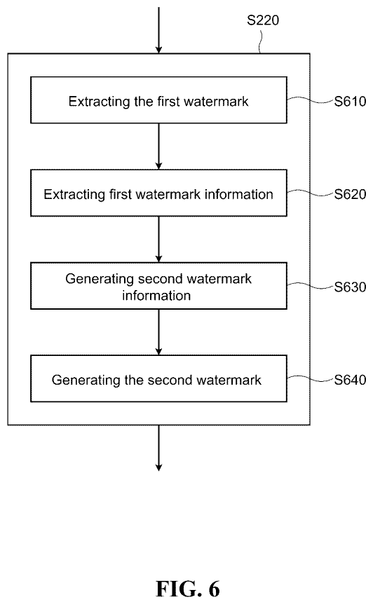

FIG. 6 is a flowchart showing a method for generating and embedding a second watermark with reference to information from the first watermark according to an embodiment of the present invention. Referring to FIG. 6, the step S220 of generating the second watermark, as illustrated in FIG. 2, may comprise: extracting the first watermark from the digital media (step S610); extracting first watermark information from the first watermark (step S620); generating second watermark information based on the first watermark information (step S630); and generating the second watermark based on the second watermark information (step S640). In other words, the information value held by the second watermark may be determined with reference to an information value contained within the previously-embedded first watermark.

According to one embodiment, the step of generating the second watermark information (step S630) may comprise extracting at least one numeral from the first watermark information, performing a computation based on the extracted numeral, and generating the second watermark information based on the computation result. The nature of the computation is not limited by the invention; any computation based on numbers is permissible, including arithmetic operations such as addition/subtraction, application of equations and/or functions, or operations excluding a certain value, such as rejecting a random value if it overlaps with the first watermark information.

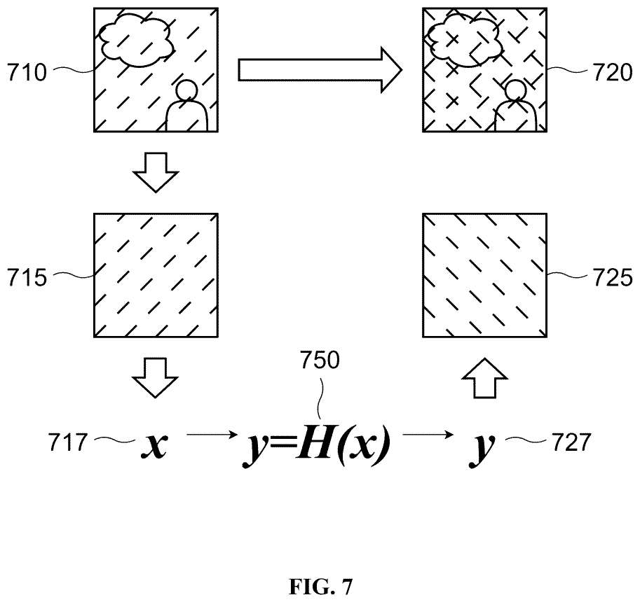

FIG. 7 is an exemplary diagram illustrating reference computation between a first watermark and a second watermark according to an embodiment of the present invention. Referring also to FIG. 6, the first watermark 715 may be extracted (step S610) from watermarked digital media 710, and an arbitrary numeral x 717 may be extracted (step S620) from the first watermark information. This numeral x 717 may be modulated through a function operation, for example, using hash function 750 to generate a numerical value y 727, which can be used to generate (step S630) second watermark information containing y 727. Subsequently, based on the second watermark information, the second watermark 725 may be generated (step S640). The generated second watermark 725 is then additionally embedded in the first watermarked digital media 710, resulting in second watermarked digital media 720.

An illustrative effect achieved by using such function operations, such as hash functions, is that the first watermark and second watermark may be independently detectable, while also being embedded in a manner that confirms the second watermark was inserted after the first. This structure supports enhanced enforcement and leakage prevention through watermarking.

In another embodiment of the present invention, the first and second watermarks may include information related to the number of times watermarking has been performed, wherein the extracted numeral may indicate the count of watermark insertions. For instance, the first watermark may indicate that it is the nth insertion, and the second watermark may be constructed so that it reflects at least n+1 watermark insertions; that is, it contains a number greater than the number in the first watermark.

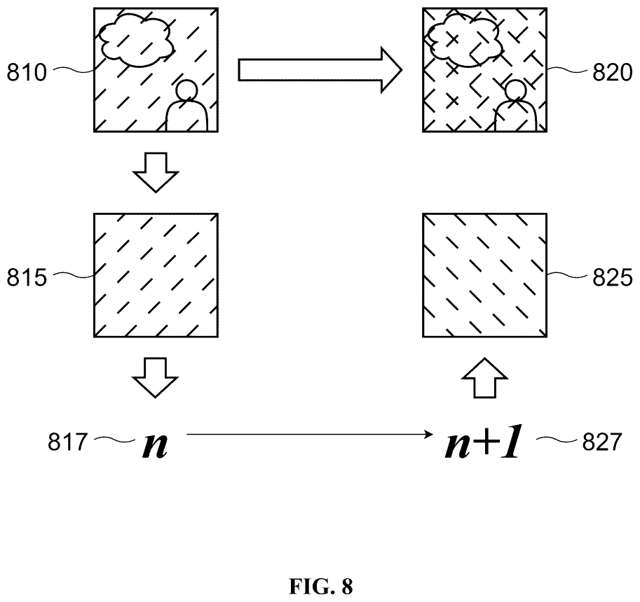

FIG. 8 is an exemplary diagram illustrating reference through numerical incrementation between a first watermark and a second watermark according to an embodiment of the present invention. Referring also to FIG. 6, the first watermark 815 may be extracted (step S610) from watermarked digital media 810, and a numerical value n 817 representing the watermark insertion count may be extracted (step S620) as part of the first watermark information. As the insertion of the second watermark increases the count by one, n 817 is incremented to n+1 827, which is then used to generate (step S630) the second watermark information. Next, based on the second watermark information, the second watermark 825 may be generated (step S640). The generated second watermark 825 is further embedded in the first watermarked digital media 810, resulting in second watermarked digital media 820.

The numerals such as x 717 and y 727 in FIG. 7, and n 817 and n+1 818 in FIG. 8, can be extracted from their respective watermarks by a variety of methods. According to one embodiment, these numerals may be included within watermark messages as part of the watermark information. In another embodiment, the numerals may be implemented via signal characteristics at the time the watermark is embedded, particularly as part of ensuring non-interference between corresponding watermarks. For example, the watermark insertion count and the carrier frequency used for watermark formation may be linked, such that incrementation of the watermark insertion count forms part of the operation that makes individual watermarks orthogonal to each other.

The step of embedding the second watermark into the digital media to generate the second digital media (step S230) is intended to encompass any process by which the second watermark is inserted on top of the first digital watermark. Preferably, the watermark embedding method is the same as that used for the first watermark, but any conventional or newly provided digital watermarking method may be used, provided it does not depart from the conceptual scope of the invention. The watermark embedding technique may be invisible or inaudible, such that it is not substantially perceptible from the embedded data by human vision or listening. However, the present invention is not limited to the aforementioned exemplary embodiments; visible or audible watermarking, or a combination of both visible/audible and invisible/inaudible watermarking, may also be used.

In an embodiment of the present invention, the step of embedding the second watermark (step S230) may be performed in conjunction with the encoding process of the second digital media. This encoding may refer to digital encoding processes specific to the type of media; for example, encoding in conformity with JPEG, PNG, GIF standards for still images, or standards such as MPEG-2, MPEG-4 Video, H.263, H.264/AVC, H.265/HEVC, H.266/VVC, VC-1, AV1, QuickTime, VP-9, VP-10, Motion JPEG, and the like for video content. It will be readily apparent to those skilled in the art that any other digital media encoding standard may be used without affecting implementation of the invention.

The step of outputting the second digital media (step S240) may refer to providing the second watermarked digital media to another recording media, device, module, functional unit, or system. In one embodiment, the output step (step S240) provides the watermarked digital media to a specific display device using a communication network. In another embodiment, the output step (step S240) may record the watermarked digital media to a recording media using a computing device with writing capabilities. In yet another embodiment, the output step (step S240) may be configured to connect directly to a digital media display device to present the watermarked digital media to a user.

In the various embodiments described above, it has been generally assumed that the first digital media already has a watermark embedded. However, according to another embodiment of the present invention, the first digital media may not have any pre-existing watermark. In such a case, the method of the present invention operates analogously to a conventional digital watermark embedding method; however, in anticipation of future redundant watermarks, it acts as a system for inserting the first watermark. Here, what has been termed as the “second watermark” in this specification should be understood as corresponding to the initial watermarking in this context. Furthermore, any procedures described as referencing the first watermark and/or its information should be understood as alternatively referencing a given default or initial value in cases where watermark embedding is performed for the first time. For example, if processing based on the number of watermark insertions is to be performed when no pre-existing first watermark exists, the insertion count may be set to one when the present (second) watermark is inserted. This may be interpreted as the first insertion having a count of one, or, alternatively, as a default value of zero for a non-existent first watermark incremented by one. Embodiments concerning digital media without a pre-existing watermark are not mutually exclusive with the previously described cases, and it is apparent that both can be realized in parallel in a single implementation of the present invention.

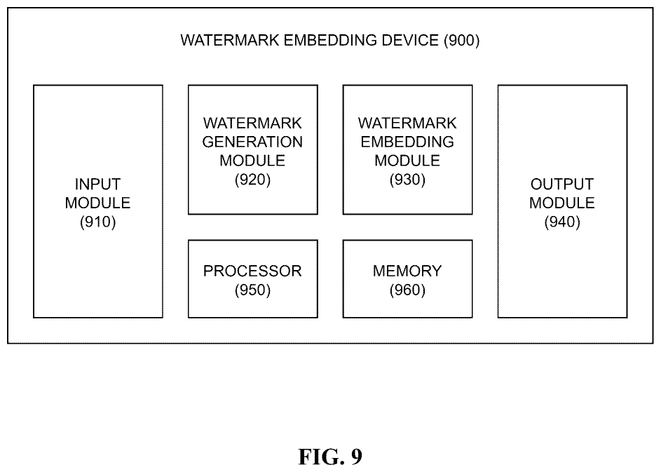

FIG. 9 is a conceptual diagram of a device for embedding a digital watermark according to an embodiment of the present invention. The watermark embedding device 900 for digital media according to one embodiment may include: an input module 910 for receiving first digital media having a first watermark already embedded, a watermark generation module 920 for generating a second watermark, a watermark embedding module 930 for embedding the second watermark into the digital media to generate second digital media, and an output module 940 for outputting the second digital media. The operation of each module can be readily understood from the descriptions of each step of the digital watermark embedding method provided above.

Each module included in the digital watermark embedding device 900 may be interconnected in various forms (such as via a bus, circuitry, or routines and subroutines) to exchange information within the device 900. Through such interconnections, in order to support computational heavy operations, the device 900 may also be configured to include a processor 950 with computational capabilities and a memory 960 connected to the processor.

As described herein, the term “processor” may refer to one or more general-purpose or special-purpose computers capable of executing instructions and responding to commands, such as a processor, controller, arithmetic logic unit (ALU), digital signal processor (DSP), microcomputer, field programmable array (FPA), programmable logic unit (PLU), microprocessor, or any similar device. Although the processor is typically described in the singular for ease of understanding, it will be evident to those skilled in the art that the processor may include multiple processing elements and/or types of processors. For example, the apparatus of one embodiment may include multiple processors, or a processor and a controller. The processor may also be implemented as a parallel processor or a multi-core processor, and various other processing configurations.

The processor may be configured to execute an operating system and one or more software applications running on that operating system. In response to execution of the software, the processor may access, store, manipulate, process, and generate data.

The software may include computer programs, code, instructions, or any combination thereof, and may control the processor to operate as desired, independently or collectively with other modules. Such software may be permanently or temporarily embodied on any type of machine, component, physical or virtual device, computer-readable storage media or device, or transmitted as a signal wave, in order to interpret or provide instructions or data to the processor. The software may also be distributed and executed over computer systems connected via a network.

Furthermore, the software may be implemented as program instructions carried out by various computer means and may be recorded or stored on the memory. The memory may be a computer-readable recording media, in which program instructions, data files, and data structures may be recorded individually or in combination. The program instructions stored in the memory may be specifically designed for the present invention, or may conform to a publicly known instruction set, such as assembly, C, C++, Java, or Python. Such instruction sets and program instructions may include machine code created by a compiler as well as high-level code executed by an interpreter.

The computer-readable recording media, including the memory described above, may encompass memory types that are temporary or volatile, such as processor cache, RAM, or flash memory, as well as more permanent or non-volatile recording media such as hard disks, floppy disks, magnetic tapes, CD-ROMs, DVDs, magneto-optical media, solid-state memory, or read-only memories (ROMs) provided in hardware. Furthermore, hard-wired circuit configurations that carry out the required operations may also be regarded as equivalent to the memory, since their connection and arrangement accomplish the same functions as a recordable media, as is apparent to those skilled in the art.

The above-described embodiments for the processor and memory are not mutually exclusive, and may be appropriately selected or combined as needed. For example, a single hardware device may function as a module composed of one or more types of the software described above, and conversely, each operation assigned to a module may be implemented as one or more software modules stored on a recording media (preferably within the memory) and executed by the processor. In such cases, the module(s) may thus be implemented as function(s) “included in” the processor.

While the present invention has been described above with reference to the drawings and specific embodiments, it should be understood that the scope of protection of the present invention is not limited by the aforementioned drawings or embodiments. Those skilled in the art will appreciate that modifications and changes may be made to the present invention without departing from the spirit and scope of the invention as set forth in the claims.

What is claimed is:

1. A method for embedding a watermark in digital media using an information processing apparatus, the method comprising:
receiving first digital media into which a first watermark has been embedded;
determining a first carrier frequency of the first watermark from the first digital media;
selecting a second carrier frequency orthogonal to the first carrier frequency using different coefficient values of the discrete cosine transform (DCT);
generating a second watermark having a spatial resolution that differs by a factor of two from the first watermark in at least one of horizontal and vertical directions;
embedding the second watermark into the first digital media based on the second carrier frequency, to generate second digital media in which the first watermark and second watermark can each be independently detected without mutual interference, based on frequency orthogonality and the difference in granularity; and
outputting the second digital media.

2. The method of claim 1, wherein generating the second watermark comprises:
extracting the first watermark from the first digital media;
extracting first watermark information from the first watermark;
generating second watermark information based on the first watermark information; and
generating the second watermark based on the second watermark information.

3. The method of claim 2, wherein generating second watermark information comprises:
extracting at least one numeral from the first watermark information;
performing a computation based on the extracted numeral to obtain a result; and
generating the second watermark information based on the computation result.

4. The method of claim 1, wherein embedding the second watermark is performed concurrently with the encoding of the second digital media.

5. The method of claim 1, wherein the second watermark, upon receiving the first digital media, includes at least one item of information selected from the group consisting of: the time of receipt, date of receipt, identification information of the receiving device, and user identification information of the receiving device.

6. The method of claim 1, wherein the second watermark, upon outputting the second digital media, includes at least one item of information selected from the group consisting of: the time of output, date of output, identification information of the output device, and user identification information of the output device.

7. The method of claim 1, wherein the first watermark and the second watermark each include information indicating a watermark embedding count, and the embedding count indicated by the second watermark is greater than the embedding count indicated by the first watermark.

8. The method of claim 7, wherein generating the second watermark comprises:
extracting the first watermark from the first digital media;
extracting information related to the watermarking count from the first watermark;
incrementing the watermarking count by at least one; and
generating the second watermark to include information corresponding to the incremented count.

9. An apparatus for embedding a watermark in digital media, comprising:
a processor capable of processing digital signals;
a memory electrically connected to the processor, the memory storing a watermark embedding algorithm;
an input interface configured to receive first digital media in which a first watermark has been embedded;
a watermark generation module configured to determine a first carrier frequency of the first watermark from the first digital media, to select a second carrier frequency orthogonal to the first carrier frequency using different coefficient values of the discrete cosine transform (DCT), and to generate a second watermark having, in at least one of a horizontal or vertical direction, spatial granularity differing by a factor of two from the first watermark;
a watermark embedding module configured to embed the second watermark into the first digital media based on the second carrier frequency, so as to generate second digital media in which the first watermark and the second watermark are each individually detectable without mutual interference based on frequency orthogonality and granularity difference; and
an output interface configured to output the second digital media.

10. The apparatus of claim 9, wherein the watermark generation module is further configured to extract the first watermark from the first digital media, extract first watermark information from the first watermark, generate second watermark information based on the first watermark information, and generate the second watermark based on the second watermark information.

11. The apparatus of claim 9, wherein the watermark embedding module includes an encoder for encoding the second digital media.

12. The apparatus of claim 9, wherein the first watermark and the second watermark each include information relating to the number of times watermarking has been performed, and the information associated with the number of times the second watermark has been embedded represents a value greater than the corresponding information associated with the first watermark.
